(19) United States
(12) Patent Application Publication
(10) Pub. No.: US 2009/0107043 A1
(43) Pub. Date: Apr. 30, 2009

(54) Replaceable liners for hydroponic and non-hydroponic plant growth systems

(76) Inventor: William Alexander Carney, Aptos, CA (US)

Correspondence Address: Walt Froloff, 273D Searidge Rd, Aptos, CA, 95003, US

(21) Appl. No.: 12/077,364

(22) Filed: Mar. 19, 2008

Related U.S. Application Data
(60) Provisional application No. 60/982,199, filed on Oct. 24, 2007.

(51) Int. Cl. A01G 31/02; A01G 27/00

(52) U.S. Cl. 47/62 R; 47/79

(57) ABSTRACT

The present invention discloses replaceable liners for maintaining clean conditions for use in artificial plant cultivation systems, through inexpensive and quickly installable tray and or reservoir disposable/recyclable liners.

### CROSS-REFERENCES TO RELATED APPLICATIONS

This application is a Continuation to Provisional Patent Application No. 60/982,199 filed on Oct. 24, 2007, and which is incorporated herein by reference in its entirety and for all purposes.

### BACKGROUND

### Field of the Invention

The present invention relates generally to liners for hydroponics and non-hydroponics plant growth systems and specifically to flood table and reservoir replaceable liners.

Current Hydroponics Systems

Since plants absorb essential mineral nutrients as inorganic ions water, growing plants using mineral nutrient solutions instead of soil. This has lead to the industry of hydroponics. In natural conditions, soil acts as a mineral nutrient reservoir but the soil itself is not essential to plant growth. When the mineral nutrients in the soil dissolve in water, plant roots are able to absorb them. When the required mineral nutrients are introduced into a plant's water supply artificially, soil is no longer required for the plant to thrive. Almost any terrestrial plant will grow with hydroponics, but some will do better than others.

Many systems have evolved and are in the market today, some better than others. Most plant growth systems on the market suffer from the maintenance costs. Electronics implemented cycle periods of flooding and ebbing the nutrient solution are used, so that relieving growers the burden of remembering, waiting and manually doing that task. However, the cleaning maintenance of plant growth systems is still sizable and is currently done manually.

Plant growth systems require mineral nutrient solutions which carry the life sustaining chemistry which breeds algae, mold and many other bacteria. These systems are designed to encourage growing organisms, cation exchange and decomposition of the organic medium itself becomes very efficient. Some systems use compost to provide nitrogen. In many systems, the build up of growth by product and waste is rapid and sizable, requiring weekly cleanings at minimum. As such, the implements must be cleaned frequently to prevent purification and plant infection.

Plants change the composition of the nutrient solutions upon contact by depleting specific nutrients more rapidly than others, removing water from the solution, and altering the pH by excretion of either acidity or alkalinity. Care is required not to allow salt concentrations to become too high, nutrients to become too depleted, or pH to wander far from the desired value.

Hydroponics fertilizers and other types of formulas for hydroponics have changed dramatically over the years. Many of these changes have resulted in measurably significant increases in plant growth rates, plant resistance to diseases and pests, and plant yields. However, one factor remains, that system equipment must be cleaned frequently and the cleaning costs in terms of time, labor and cleaning agents is enormous.

A homemade system can be constructed from plastic food containers or flooding trays cascading to a reservoir tub, with aeration provided by an aquarium pump, aquarium airline tubing and aquarium valves. Clear containers are covered with aluminum foil, butcher paper, black plastic or other material to exclude light, thus helping to eliminate the formation of algae, but non-clear plastic will do fine as well. The nutrient solution is either changed on a schedule, such as once per week, or when the concentration drops below a certain level as determined with an electrical conductivity meter. Whenever the solution is depleted below a certain level, either water or fresh nutrient solution is added. In raft solution culture, plants are placed in a sheet of buoyant plastic that is floated on the surface of the nutrient solution. That way, the solution level never drops below the roots.

In continuous flow solution culture the nutrient solution constantly flows past the roots. It is much harder to automate than the static solution culture because sampling and adjustments to degree and nutrient concentrations can be made in a large storage tank that serves potentially hundreds of plants. A popular variation is the nutrient film technique, or NFT whereby a very shallow stream of water containing all the dissolved nutrients required for plant growth is recirculated by the bare roots of plants in a watertight gully, also known as channels. Ideally, the depth of the recirculating stream should be very shallow, little more than a film of water, hence the name ‘nutrient film’. This ensures that the thick root mat, which develops in the bottom of the channel, has an upper surface which, although moist, is in the air. Subsequently, there is an abundant supply of oxygen to the roots of the plants. A properly designed NFT system is based on using the right channel slope, the right flow rate and the right channel length. The main advantage of the NFT system over other forms of hydroponics is that the plant roots are exposed to adequate supplies of water, oxygen and nutrients. In all other forms of production there is a conflict between the supply of these requirements, since excessive or deficient amounts of one results in an imbalance of one or both of the others. NFT, because of its design, provides a system where all three requirements for healthy plant growth can be met at the same time, providing the simple concept of NFT is always remembered and practiced. The result of these advantages is that higher yields of high quality produce are obtained over an extended period of cropping. A downside of NFT is that it has very little buffering against interruptions in the flow e.g. power outages, but overall, it is probably one of the more productive techniques.

However, even these, require that cleaning be done regularly. A home system, flooding tray and reservoir set, will require scrubbing and a good cleaning which will consume approximately 2 hours of labor. The chemical agents, for this simple flooding tray and reservoir clean, will require ½ quart of cleaning agent. This is not your typical cleaning agent, as it cannot be too harsh as to destroy equipment, or leave traces of poison for the plants. The cleaning agents will typically cost in the neighborhood of $30/quart. Thus a weekly cleaning for a simple tray-reservoir system will typically cost approximately $15 in cleaning agent and 2 hours of manual labor. This will amount in excess of $35 in costs. What is needed are less expensive solutions to maintain a clean and sanitary plant system environment while maintaining conditions conducive to plant growth.

### SUMMARY

The present invention discloses a replaceable plant growth system container liner. The liner comprises a tray or tub containing plants for growing in hydroponic conditions, a mechanism for anchoring the liner edge to above the tray or tub fluid content line, whereby upon fluid nutrient addition, the plastic liner insulates the tray or tub from the fluid, liner designed to be a temporary barrier periodically replaceable for plant health and tray or tub sanitation. Reinforcement areas, perforations, and standard dimensions increase utility and lower cost.

### BRIEF DESCRIPTION OF DRAWINGS

FIGS. 1a and 1b are side and front views of hydroponics system flood tray respectively, in accordance with an embodiment of the invention.

FIGS. 2a and 2b are side and front views of hydroponics system reservoir respectively, in accordance with an embodiment of the invention.

FIG. 3 is a top view of a hydroponics container with lining, in accordance with an embodiment of the invention.

FIG. 4 is side view schematic of hydroponics cascading tray and reservoir set in accordance with an embodiment of the invention.

### DETAILED DESCRIPTION

Specific embodiments of the invention will now be described in detail with reference to the accompanying figures.

In the following detailed description of embodiments of the invention, specific details are set forth in order to provide a more thorough understanding of the invention. However, it will be apparent to one of ordinary skill in the art that the invention may be practiced without these specific details in lieu of substitutes. In other instances, features have not been described in detail to avoid unnecessarily duplication and complication.

### OBJECTS AND ADVANTAGES

The present invention provides a simple system to keep plant growth system facilities clean with a minimum of labor, chemical cleaner and waste. Keeping a sanitary environment for plant cultivation is currently a very labor intensive proposition, as manual scrubbing is typically involved. Hence, an object of the invention is to greatly reduce or eliminate the labor in keeping facilities clean and amenable to plant growth.

Chemical solutions for the removal of buildup of growth limiting compounds formed between the water and nutrients and the plastic tables and reservoirs are relatively expensive. This is because most common or inexpensive cleaning agents are too abrasive or are damaging to the facilities or equipment. Hence the market has produced acceptable cleaning agents at a price. An object of the invention is to eliminate the need for these chemical cleaning solutions.

The waste industry offers plastic liners in the form of garbage bags, which are labor saving and relatively inexpensive. An object of the invention is to provide a similar technology to plant growth systems, relatively inexpensive flood tray, reservoir and plant system container replaceable liners. It is estimated, projecting form similar mass produced products, that average size liners can be manufactured in volumes of less than $1/liner. This gives an effective 3500% improvement over the current manual method of cleaning equipment manually.

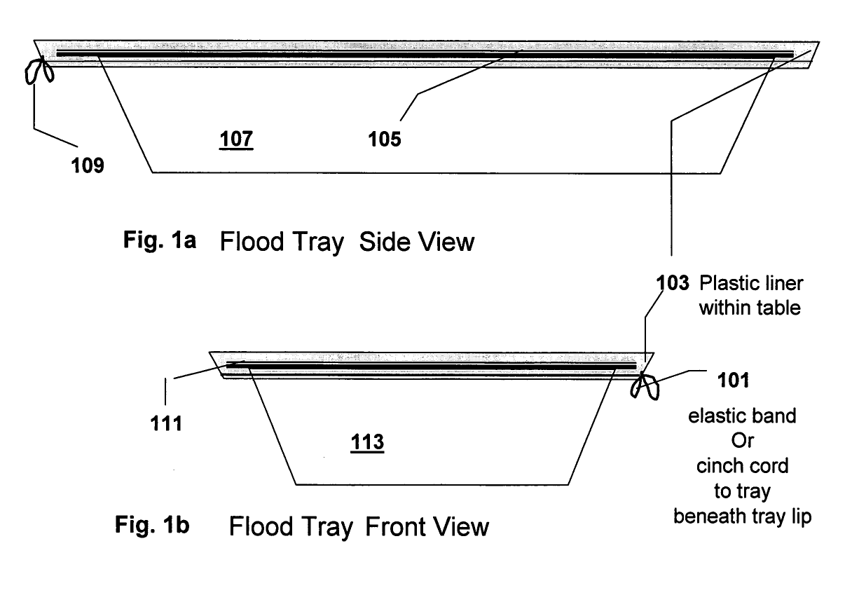

FIG. 1a and 1b are side and front views of hydroponic flood tray respectively, in accordance with an embodiment of the invention.

In an embodiment of the invention, a simple disposable/recyclable/replaceable plastic relatively strong rectangular flat aspect shaped envelope with elastic or cinch cord to tighten bag edge can be used by substantially enclosing the flood tray application. In another embodiment, a shallow enclosing envelope with a wide throat forming an edge with an elastic or cinch cord can be used. In another embodiment, the tray bottom will have channels forming non-flat bottom and the liner will be quested to be more conformable with the non-flat bottom.

FIG. 1a illustrates a simple flood tray 107 with a lip 105 at the top over which a replaceable plastic liner 103 is draped, using a cinch cord 109 or other liner securing mechanism, to close the liner edge under the tray lip 105 forming a movement restraining mechanism for stabilizing the liner. The liner will conform to the tray more or less, to minimize liner movement against the tray. Movement between the liner and tray may cause tears or ruptures in the liner, and a breach will require a scrubbing clean, invalidating the use of the liner.

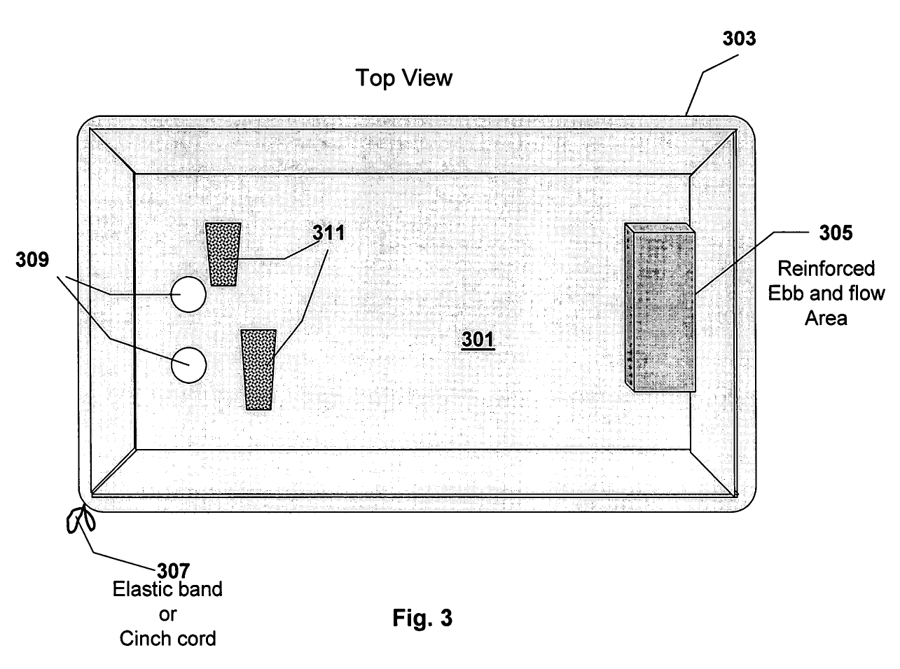

FIG. 1b is a front view illustration of tray 113, showing the liner 103 draped over the tray 113 lip 111 and secured by cinch cord 101. The tray aspect ratio is typical, and can be helpful in standard sizing of liners. The thin plastic liner forms a barrier much like plastic bag, but plants are removed and fluid drained before liner replacement. However, the liner material strength will differ but can be minimized in thickness, if the material provides a leak proof seal. Porous materials will allow fluid to leak onto the tray and form pockets of purification and decay. Where areas must support higher stresses, as shown in the FIG. 3 optional water intake and outflow or ebb and flow fluid recycling points, reinforcing layers 305 can be made by adding wall thickness to the liner.

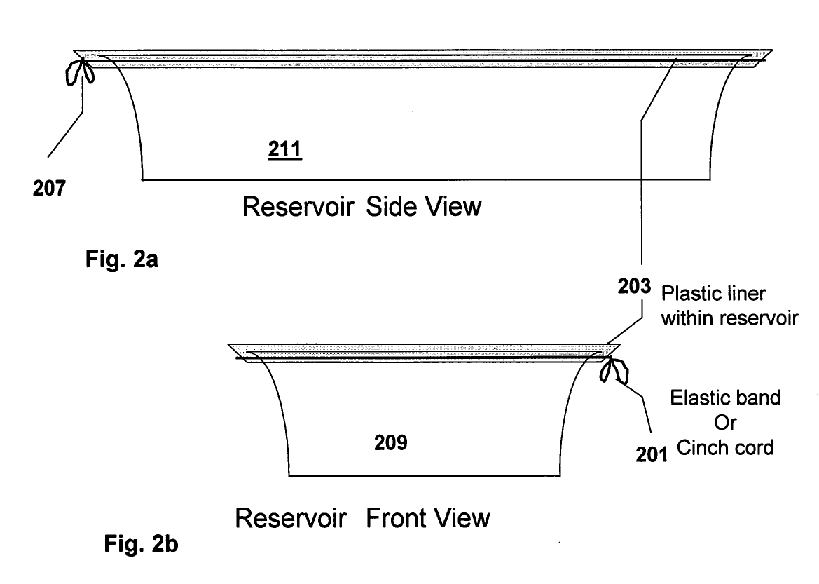

FIGS. 2a and 2b are side and front views of hydroponics reservoir or tube respectively, in accordance with an embodiment of the invention.

These embodiments are similar to the flatter aspect ratio flood tray applications, and with a difference in sizes and geometry container that the liner must accommodate. FIG. 2a shows the reservoir 211 side view shown comparatively with the FIG. 2b reservoir 209 front view. The liner edge 203 securing or attaching mechanism 201 can be an elastic band, sewn, glued, or thermally bonded to the liner, or cinch cord 201 207 then tightened constricting the edge length around the lip of the tray or reservoir. In and embodiment of the invention, the liner can be plastic material. Various liner material colors can be used, depending on the advantages sought, such as to reflect unused light or to inhibit algae or mold growth from white color, or maximum tray/reservoir protection from black color liner. Other advantages using other colors can be used also.

The liner should fit conformably with in the container, to minimize chances of movement, tearing, wearing and breaching the fluidic integrity of the liner. The liner can also be made materially stronger by increasing thickness, and this will be a trade off, the more active the liner in moving, the larger the thickness to prevent breaches. Flooding trays and reservoirs for plant systems, have standard sizes. These standard dimensions are known and aspects of the invention exploit those in contemplation of mass production of liners to reduce costs and exploit market container current standards.

FIG. 3 is a top view of a hydroponics container 301 with lining 303, in accordance with an embodiment of the invention. In an embodiment of the invention, reinforcement areas 305 can be applied to support higher stress or wear points. A thicker area of reinforced plastic 305 protects the liner 303 from tearing or stretching at water/nutrient induction and outflow regions, for use with ebb and flow, flood and drain, or drip hydroponics systems for plant cultivation. Perforated regions 309 can be made for insertion of drain plugs 311, so that liner tears do not propagate from the local drain or accouterment areas, for openings to facilitate the watering cycle and draining. and perforations. In other embodiments, the re-enforcement areas 305 will include the drain holes 309 as these also sustain liner stress risers. Elastic band cinch cords 307 inside the liner edge or other liner securing mechanisms can be used.

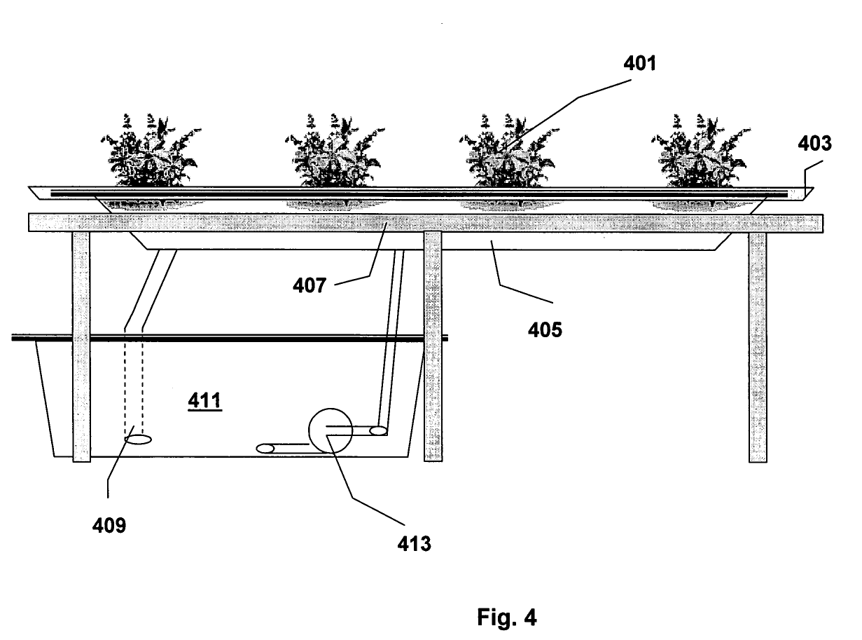

FIG. 4 is side view schematic of hydroponics cascading tray and reservoir set in accordance with an embodiment of the invention. This illustration shows a typical small plant cultivation system, with plants 401 positioned in the flood tray 405 on a elevating structure 407 which can be a simple table. Nutrient is periodically pumped 413 from the reservoir 411 to the flooding tray 405, where the nutrient and water flow across the plant 401 root systems. The flood tray liner 403 prevents the fluid from contact with the flood tray 405, maintaining a fluid proof boundary. The wash/draining cycles the nutrient and waste back through the drain conduit 409 and into the reservoir, where chemistry can be measured and augmented or not.

Upon cleaning, the plants 401 are removed to temporary location, the tray 405 is drained 409 as well as the reservoir 411.

FIG. 4 shows the installed thin flexible tray 405 and reservoir 411 dimensionally conforming replaceable liners 403 with installed a nutrient fluid feed and return fluid path providing periodically flowing water and nutrient through plant root configuration, exposing plants to nutrient feed at set intervals. Reservoir 411 liner not shown in FIG. 4 to illustrate the independence between containers and draw the distinction from liner drawn and non-liner installed containers. Light from above, not shown, provides natural or artificial light for the plant photosynthesis. The savings in cleaning comprise periodically replacing the liners with frequency sufficient to provide acceptable nutrient and plant sanitation.

The pump 413 and any other equipment is relocated temporarily, and the liners 403 removed. Liners can be disposed of or recycled and new liners installed, the equipment and plants re-positioned.

An aspect of the invention, by virtue of periodic liner replacement, reduces and eliminates labor in cleaning trays and reservoirs.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A plant growth system container liner comprising:
a tray or tub containing plants for growing in hydroponic conditions;
a thin loosely conformable replaceable liner fitting the dimensions of the tray or reservoir more or less;
a mechanism for securing the liner edge to above the tray or tub fluid content line, whereby upon fluid nutrient addition, the plastic liner insulates the tray or tub from the fluid, liner designed to be a temporary barrier periodically replaceable for plant health and tray or tub sanitation.

2. A plant growth system liner as in claim 1 further comprising a perforation or liner puncture for placement of drain plug.

3. A plant growth system liner as in claim 1 wherein the mechanism for securing the liner edge is an elastic band or draw string coupled to and serving to tighten the liner edge around the tray or reservoir lip, preventing the liner edge from sliding into the tray or reservoir.

4. A plant growth system liner as in claim 1 further comprising installation maintenance of liner removal and replacement substantially reducing the labor in maintaining acceptable plant sanitation.

5. A plant growth system liner as in claim 1 further comprising a liner replacement cycle eliminating the need for tray or tub chemical cleaning or cleaning solutions.

6. A plant growth system liner as in claim 1 wherein the liner is made of a plastic material, rubber, fluid proof paper or other fluid holding material.

7. A plant growth system liner as in claim 1 wherein the liner thickness is a minimum to maintain tray or tub chemical insulation integrity.

8. A plant growth system liner as in claim 1 further comprising reinforcing sections subject to higher material stresses.

9. A method of obtaining acceptable taste characteristics in plants grown artificial plant growth systems, comprising the steps of:
installing at least one set of cascading tray to reservoir containers;
installing thin flexible tray and reservoir dimensionally conforming replaceable liners;
installing a nutrient fluid feed and return fluid path with periodically flowing through plant root configuration, exposing plants to nutrient feed at set intervals;
providing natural or artificial light for the plant photosynthesis;
periodically replacing the liners with frequency sufficient to provide acceptable nutrient and plant sanitation,
whereby growing plants in plant growth systems with replaceable liners can sustain growth in maintainable sanitation conditions.

10. The method of obtaining acceptable taste characteristics from plants grown in artificial plant growth system as in claim 9 wherein the replaceable liner is made from thin conformable flexible plastic material.

11. The method of obtaining acceptable taste characteristics from plants grown in artificial plant growth system as in claim 9 wherein the replaceable liner edge contains a securing mechanism for maintaining the liner edge above plant tray and or reservoir fluids.
